(19) United States
(12) Patent Application Publication
(10) Pub. No.: US 2003/0206760 A1
(43) Pub. Date: Nov. 6, 2003

(54) Computer keyboard rocking key supplements vertical motion with a rocking motion to provide access to a second character

(76) Inventor: Harry E. Emerson, Succasunna, NJ (US)

Correspondence Address: HARRY E. EMERSON, 27 GARDEN COURT, SUCCASUNNA, NJ, 07876, US

(21) Appl. No.: 10/427,885

(22) Filed: May 1, 2003

Related U.S. Application Data
(60) Provisional application No. 60/377,512, filed on May 2, 2002.

(51) Int. Cl. B41J 5/08

(52) U.S. Cl. 400/472

(57) ABSTRACT

A computer keyboard having a key with a rocking motion in addition to a vertical motion. Typing the key in the vertical motion types the standard character for the key, while typing the key in its rocking motion types the Shifted character for the key.

This application claims the benefit of U.S. provisional patent application Serial No. 60/377,512, filed May 2, 2002.

### BACKGROUND OF THE INVENTION

1. Field of the Invention

The present invention relates to computer keyboards, including the nature of keys provided on the keyboard, the layout of those keys, and the functionality provided by those keys in relation to the computer system.

2. Description of the Prior Art

Computer keyboards have become standardized in their basic format for use with a variety of computers and computer operating systems. In particular, this document refers to computer keyboards compatible with computers designed according to Microsoft Corporation hardware specifications and the Intel Corporation microprocessor and system design (so called Wintel computers, an acronym referring to Microsoft Windows and Intel Corporation), and to keyboards compatible with computer operating systems capable of running on these computers, including the various Microsoft operating systems and varieties of the Unix operating system, especially Linux and its derivatives.

The following section describes the evolution of the computer keyboard from the introduction of the original IBM PC to today's current versions, and describes the function of the major keys and key groupings.

83-Key PC/XT Keyboard Layout

As illustrated in FIG. 1, the very first PC keyboard was the 83-key keyboard produced by IBM for the very first IBM PCs and PC/XTs in the early 1980s. This design was copied nearly verbatim by most of the early PC “clone” makers, and was the standard for PCs of this era. From a layout standpoint, however, there are numerous problems with the original 83-key layout, which caused many typists a great deal of frustration. Here are some of the main issues with this layout, when it is contrasted to more modern configurations:

Cramped Physical Grouping: It is a very “cramped” layout. All of the keys except the function keys are physically contiguous, giving the layout a very “busy” appearance. This is made worse by the fact that many keys are of odd sizes, and there is no clear vertical “dividing line” for the eye between the main typing area and the numeric keypad. Even the function keys are not separated very much from the rest of the layout. Overall, it looks like a “jumble of keys”. This may seem a trivial matter but has an impact on those learning to use the PC.

Poor <Shift> Key Size and Location: The <Shift> keys are rather small, and even worse, there is an extra key (backslash and vertical bar) between “Z” and the left <Shift> key, causing touch typists to accidentally hit this extra key when reaching for the left <Shift> key.

Poor <Enter> Key Size and Location: The <Enter> key is also rather small, and too far to the right, with an extra, rarely needed key (back-quote and tilde) between the main typing area and the <Enter> key. The <Enter> key doesn't line up vertically with the right <Shift> key.

Strange <Ctrl> Key Size and Position: Many users found the <Ctrl> key to be too large and in the place where they expected to find the <Caps Lock> key. In turn, the <Caps Lock> key is in an odd location.

No Dedicated Cursor and Navigation Keys: The only cursor and navigation keys are the ones on the numeric keypad. Since the cursor and navigation keys are needed almost all the time, this greatly reduced the utility of the numeric function of that keypad. (Remember that the most popular application in the early days of the PC was Lotus 1-2-3, a spreadsheet program used by financial people who needed both cursor movement keys and the numeric keypad.)

No Indicator LEDs: These early keyboards communicated unidirectionally with the system and could not accept the commands now used to control the indicator LEDs, so they included none. This caused much confusion, particularly given the frequency with which the <Num Lock> key needed to be pressed in order to flip between the cursor keys and the numeric keys. Some PC clone keyboards came out with indicator LEDs on them that were controlled by the keyboard itself to indicate the status of the <NumLock>, <CapsLock>, and <ScrollLock> keys. These mostly worked OK, but had the potential for becoming “out of sync” with what the system thought the state of the toggle modifier keys was.

Left-Side Function Keys: Many users disliked having the function keys on the left hand side of the keyboard, principally because early software would often provide visual cues on the bottom of the screen indicating what roles the different function keys would play in that application, and users wanted to see the function keys “line up” with these cues.

84-Key AT Keyboard Layout

IBM received a lot of complaints about the first keyboard design and eventually made improvements to it. The first evolution of the keyboard was the 84-key keyboard layout introduced with the first IBM PC/AT, illustrated in FIG. 2. (The LED indicators are above the numeric keypad and not shown in this photo.) This is sometimes called the AT Keyboard. There are several definite improvements with this layout, compared to the 83-key keyboard:

Better Physical Grouping: The keyboard has three distinct key physical groups, with the numeric keypad placed distinctly to the right. The three groupings have clean vertical lines. The numeric keypad has been reorganized. Overall, the keyboard has a much more organized and understandable appearance.

Improved <Shift> and <Enter> Keys: The left <Shift> key, and the <Enter> key, have been enlarged, and the seldom-used “intervening” keys relocated.

LED Indicators: With the new internals of this keyboard (see below), LED indicators for the “lock” functions were added.

Extra “System Request” Key: This is the “84th key”. It was mostly used for special control operations for PCs operating in communication with mainframe computer systems.

However, many of the layout issues with the original design remained. The biggest concern that remained unaddressed was the continued sharing between the numeric keypad, and the cursor and navigation keys. The function keys are still on the left-hand side, and the <Ctrl> and <Caps Lock> keys are still different from what a typist would expect.

This keyboard was changed internally from the PC/XT model as well. The interface was made bidirectional, allowing the system to send commands to the keyboard, and enabling the control of the new LED indicators. The signaling and interface protocols created with this first PC/AT keyboard are still used today, even though the 84-key layout is no longer used, having been replaced by the “Enhanced” 101-key keyboard.

101-Key “Enhanced” Keyboard Layout

In 1986, IBM introduced the IBM PC/AT Model 339. Included in this last AT-family system was the new Enhanced 101-key keyboard illustrated in FIG. 3. This 101-key keyboard would become the de-facto standard for keyboards through the current day. Even today's 104-key Windows keyboards and variants with extra buttons and keys are based on this layout. The “Enhanced” keyboard was electrically the same as the 84-key AT keyboard, but featured a radically redesigned key layout. The major changes included these:

Dedicated Cursor and Navigation Keys: Finally, separate keys were provided for cursor control and navigation. This enabled the numeric keyboard to be used along with the cursor and navigation keys. The cursor keys were also made into an “inverted-T” configuration for easier movement between the “Up” key and the “Down” key with a single finger.

Relocated Function Keys: The function keys were moved from the left-hand side of the keyboard to a row along the top, and divided into groups of four for convenience.

Extra Function Keys: Two additional function keys, <F11> and <F12> were added to the keyboard.

Relocated <Esc> and <Caps Lock> Keys: The <Esc> key was moved back to the left-hand side of the keyboard, and placed up above the main typing area. The <Caps Lock> key was moved above the left <Shift> key.

Extra <Ctrl> and <Alt> Keys: Additional <Ctrl> and <Alt> keys were added on the right side of the <Space Bar>.

Extra Numeric Keypad Keys: The numeric keypad was fitted with an additional <Enter> key, as well as the “/” (divide operator) that had been missing up to that point.

Compared with the 84-key keyboard the Enhanced keyboard layout was perceived by most users to be far superior. It was an immediate hit despite its one obvious inferiority to the AT keyboard due to the smaller main <Enter> key.

With these improvements, the 101-key keyboard layout became the standard, and was modified only slightly by the nearly identical 104-key Windows keyboard which is the standard now. Although the 101-key/104-key designs are the “standard”, some manufacturers have introduced variations of the basic design to make minor improvements. For example, a common modification is to enlarge the <Enter> key back to its “84-key layout size”, and squeeze the backslash/vertical-pipe key between the “=/+” key and the <Backspace>.

102-Key “Enhanced” Keyboard Layouts

Several slightly modified versions of the regular American English 101-key Enhanced keyboard were created by IBM for by non-English PC users. These keyboards are virtually identical to the regular 101-key Enhanced keyboards, incorporating just slight differences from the regular U.S. keyboard. Considering the United Kingdom layout as an example, the following changes have been made:

The regular number “3” key now yields “£” instead of “#” when shifted.

The back-quote key yields the “-” (horizontal bar) symbol when shifted instead of a tilde (“˜”).

The main <Enter> key has been enlarged; it is now L-shaped again (though upsidedown}

An extra key (the 102^{nd}) containing the supplanted “#” and “˜” symbols has been added to the left of the main <Enter> key. (This seems a step backwards given the complaints about an extra key in this location in the 83-key layout.)

Another step backwards: the backslash/vertical bar key has been relocated back to its former place—to the right of the left <Shift> key.

104-Key “Windows” Keyboard Layout

As Windows became the predominant operating system in the PC market, Microsoft realized that many common Windows functions had no simple keyboard shortcuts to activating them. Seizing their leadership position, they created a specification for a new variant of the 101-key keyboard that includes special keys to activate common Windows functions. This design is the 104-key “Windows” keyboard, illustrated in FIG. 4.

This layout is identical to the 101-key Enhanced layout with the exception of the additional three keys: one Windows key on either side of the <Space Bar>, and a Windows context menu (right-click) key to the right of the <Space Bar>. This layout makes room for them by stealing real estate from the <Alt>, <Ctrl> and <Space Bar> keys along the bottom of the keyboard. In addition to the new Windows keys, the particular keyboard model shown in the illustration of FIG. 4 incorporates the larger main <Enter> key, enabled by moving the backslash/vertical pipe key up one row, placed next to the now-smaller backspace key. Although the particular model as shown incorporates this <Enter> key modification, the majority of Windows keyboards on the market incorporate the <Enter> key layout of the 101-key Enhanced keyboard. The functions of the two types of Windows keys are as follows:

“Windows” Keys: Two keys, one to the left of the <Space Bar> and one to the right, are used to activate various functions within the operating system. If either is pressed by itself, it puts the Windows task bar in the foreground and opens the Windows start menu. (Note that this is identical to the function performed by the key combination <Ctrl>+<Esc>). The Windows keys are also like modification keys, as they enable several “short cut” actions through special key combinations such as opening the Windows Explorer by simultaneously pressing a Windows key and the <E> key.

Context Menu Key: This key, on the right-hand side of the keyboard, is used to simulate right-clicking the mouse at its current location. Under standard Windows functionality, this opens up a context menu of commands relevant to the Window or object the mouse was over at the time the key was pressed.

Since the Windows keyboard offers some flexibility that the regular Enhanced layout does not, and its cost of production is virtually unchanged, it quickly replaced the Enhanced layout as the de-facto standard on most PCs. Most keyboards today, whether they are included with new PCs or sold separately, are some variation of the 104-key Windows keyboard layout.

Modern 104-key Windows Keyboards with Special Purpose Keys

Many specialty keyboards have extra keys or buttons, above and beyond the keys normally found on “standard” keyboards. These are becoming increasingly popular as companies look to provide convenience features on the keyboard, and possibly differentiate their offerings from those of competitors. Keyboards dubbed “Internet keyboards” or “multimedia keyboards” usually have at least some of these extras.

These special keys are usually provided in addition to the regular 104 keys of a standard Windows keyboard, squeezed in along the top of the keyboard or on the right-hand or left-hand side. They of course differ by keyboard type, however, they commonly fall into the following categories.

Internet Shortcuts: A series of buttons to implement common Internet functions, such as connecting to the 'net, or opening a web browser or email software.

Audio Controls: Buttons that let you raise or lower your PC's sound volume, mute the sound, and so on. Some also include buttons that implement standard CD player functions: start/stop, pause, next, previous and such. Some include a rotary volume control.

Mouse Controls: Buttons that simulate movement of the mouse, or mouse clicks.

An example of a 104-key Windows keyboard with additional special purpose keys is illustrated in FIG. 5. This Hewlett-Packard keyboard is just packed with extra buttons and features. These include numerous Internet buttons, audio controls, CD player controls, and a rotary volume control (visible in the upper right hand corner).

Programmable keyboards which allow the user to define the role of individual keys also typically have extra keys, which are used to enable programming modes. Also, some foreign-language keyboards have additional keys corresponding to special characters required for those languages.

Since “extra” keys are non-standard and differ for each keyboard, special drivers or software are required to enable the special functions. Otherwise, the operating system won't know what to do with the unexpected, non-standard scan codes, and will probably just ignore them. More popular keyboards may have support built into Windows, and some foreign-language keyboards may also have native support. Otherwise you will need driver software from the maker of the keyboard.

Description of the Major Types of Keys

This section describes the purpose and operation of the major types of keys found on the 101-key and 104-key standard keyboards. The primary typographic keys include the following:

Alphabetic Keys: The keys A through Z. Regular keypresses produce lower-case letters, and shifted keypresses create upper-case letters. <Caps Lock> reverses the <Shift> key functionality.

Numeric/Punctuation Keys: These are the numeric keys along the top of the keyboard, above the alphabetic keys. Shifted, they produce various punctuation and special symbols. The numerics are pretty much universal on English-language keyboards; the punctuation symbols can be different depending on region. For example, the “#” key in the United States is a “£” symbol in the United Kingdom.

Other Main Punctuation Keys: Most of the other punctuation keys on the keyboard are located just to the right of the alphanumeric keys mentioned above. While they have special meaning in some software applications, they are “just characters” most of the time.

“White Space” Keys: These include the primary (main) <Enter> key, the <Tab> key and the <Space Bar>. These keys are used for formatting text, and to delimit text entries and commands. Collectively they are often referred to as “white space” since they are characters that separate “real” characters without containing any information in and of themselves. There is also a secondary <Enter> key that is part of the numeric keypad.

<Delete> and <Backspace> Editing Keys: In text-based applications—or in text fields within other applications (for example, a Web browser)—these keys are usually used in conjunction to allow deleting of characters. The standard followed in most software is that the <Delete> key removes a character to the right of the insertion point, and the <Backspace> key removes a character to the left of the insertion point. In other contexts such as word processors and email programs, the <Delete> key may be used to delete or remove any type of object; in these applications, regions of text and objects may be selected, for example, by using the techniques described for the <Shift> key, and then deleted by pressing the <Delete> key.

One of the most important advances of the new 101-key “Enhanced” keyboard created by IBM was the creation of separate, dedicated cursor-control and navigation keys. These had formerly been accessible only by using the numeric keypad. On modern keyboards these important keys are generally placed between the numeric keypad and the main typing area. The cursor control and navigation keys are also still also available using the numeric keypad, of course, but this is rarely used today. This set of keys includes the following:

Arrow Keys: These keys permit motion in most software programs in any of the four standard directions that exist in two dimensions: up (north), down (south), left (west) and right (east). In many programs these perform functions similar to those that a mouse does, simulating two-dimensional movement. Some keyboards actually have eight arrow keys; the additional four keys are diagonals that correspond to the “northwest”, “northeast”, “southwest” and “southeast” directions. The default arrangement is an “inverted-T” configuration. Some keyboards may use instead a “diamond pattern”, with the up arrow key higher.

<Page Up> and <Page Down>: These keys (sometimes labeled “PgUp” and “PgDn”) are used in software programs primarily for one-dimensional scrolling, for example, to go up or down one page in a spreadsheet program, word-processing document, Web page and so on.

<Home> and <End>: The <Home> key is usually used to go to the left side of the current line in a document, and the <End> key to the right side. The current line is the line of text having the active cursor, meaning the location on screen where the next keyboard action will take place.

The keyboard contains several keys that serve primarily to alter the function or meaning of other keys. They are often used in combination with another key (typically by holding them down and then pressing the other key) or are typically used to set a particular keyboard state. These will be referred to as modification keys, grouped into two different sub-categories. The first are temporary modification keys, because they modify other keys only while held down. This includes:

<Shift> Keys: These two keys are near the bottom of the keyboard, one on either side of the main typing area. They enable access to capital letters, and also to the “alternate” functions printed on the keycaps above the unshifted symbol or function shown. So for example, holding the <Shift> key down and pressing the equal sign (“=”) generates a plus sign (“+”). The <Shift> keys also change the behavior of the function keys in most software programs; for example, <Shift>+<F6> is different than just <F6>. The <Shift> key functions within Windows applications to create a selected region of text or objects (or both) when used in conjunction with the navigation keys; holding the <Shift> key down while simultaneously pressing an arrow key, the <Home>, <End>, <Pageup>, or <PageDown> keys will create a selected region. A selected region can be deleted with the <Delete> key, or can be moved, copied or have other actions performed on it according to the capabilities of the software application being used.

<Ctrl> Keys: These are the “control keys”; one is located on either side of the typing area. Sometimes the keycap says “Control” instead of the shortened “Ctrl”. These keys are used in combination with regular alphanumeric keys and also the function keys to control special features and functions in software programs.

<Alt> Keys: These are the “alternate control keys”. They operate the same way the <Ctrl> keys do; their presence just lets complex software have more options. For example, <Alt>+<F6> can be a different function than <Ctrl>+<F6>. The <Alt> keys are also used for ASCII code generation.

<Insert>: In modern computing systems this key functions as a toggle key to switch between the normal “insert mode”, where all typed characters are automatically inserted, and “replace mode”, where typed characters replace those at the text insertion point. Historically it was used to insert a space in a text area each time it is pressed, but that usage is now rare.

The temporary modification keys can be combined if held down. For example, holding down <Shift>+<Ctrl>+ the up arrow in the Microsoft Word application will select the entire current paragraph.

The second sub-category contains locking modification keys. These are toggle keys—they change the function of other keys until they are pressed again to cancel the effect:

Caps Lock: When pressed, causes the function of the <Shift> keys to be reversed, but only for letter characters; other keys are unaffected. When active, the Caps Lock LED will be lit.

Num Lock: Enables the numbers on the numeric keypad when activated, and lights the Num Lock LED as well. When not active, the numeric keypad's keys generate cursor-control functions instead. This functionality dates back to the earliest PCs, which did not have dedicated cursor-control keys; today the cursor-control functions on the numeric keypad are redundant, which is why many people leave Num Lock always enabled.

Scroll Lock: Lights the Scroll Lock LED and causes some software programs to alter their behavior when certain other keys are pressed. In particular, when Scroll Lock is active, the cursor keys are often used to scroll the visible document rather than change position within it. This is not used nearly as much as the other two.

Lastly, the 101-key and 104-key keyboards include some miscellaneous keys not easily categorized; they are:

Function Keys: The function keys are a set of twelve numbered keys that are used by different software programs for a variety of different purposes. They are sometimes called programmable function keys or just F-keys or PF-keys. The original PC keyboard designs had 10 function keys, arranged in a 2×5 matrix on the left-hand side of the keyboard. With the introduction of the 101-key Enhanced keyboard, this was expanded to 12 keys, which were moved to a single row along the top of the keyboard. The exact duty of the function keys depends entirely on how the software chooses to interpret them.

<Escape>: The Escape key is usually used as an “exit” key of sorts by programs, to cancel commands or get out of something. It is also used in some contexts to change the meaning of subsequent characters.

<Print Screen/Sys Rq>: When pressed from DOS, this key causes the contents of the current screen of text to be sent to an attached printer. From within Windows, it copies the contents of the screen, in graphical format, to the Windows clipboard. The alternate use of this key is for the “system request” function. This is a historical command originally based on older IBM terminal designs, and is not really used any more.

<Pause/Break>: When pressed by itself, pauses the display or operation of some software programs. When pressed in combination with the <Ctrl> key, sends a “break” command that will interrupt some software programs or DOS commands. (You can do the same thing with <Ctrl>+C).

Key Groupings

The 101-key and 104-key keyboards are divided into seven major key groupings. Referring to FIG. 3, they are: a) the main alphanumeric (typewriter) section 20; b) the numeric cluster 22; c) the function keys 24; d) the Escape key 26; e) the arrow cluster 28; f) the miscellaneous key group 30 comprising <PrintScreen>, <ScrollLock>, and <Pause>; and g) the navigation key group 32 comprising <Insert>, <Delete>, <Home>, <End>, <PageUp>, and <PageDown>.

Prior Art Deficiency and Opportunity for Improvement

As reported in the preceding narrative, there has been development and advancement in the design, functionality, and usability of the computer keyboard over the last two decades, driven primarily by deficiencies and difficulties experienced by the user community. However, not all needs and opportunities for improvement have been entirely obvious to previous developers, and the pretext of this patent application is that there remains room for improvement.

In particular, Shifted key operations require two hands, one to operate the Shift key and the other to operate the desired character or function key. The Tab is used extensively in spreadsheet operations to move from the active cell to the next cell to the right, and Shift-Tab is used to move to the left. In some word processing and editing applications, the Tab key indents the current line of text, and Shift-Tab out-dents the current line of text. The Tab function would be more useful if the Tab key could cause either a forward or reverse movement of the Tab.

Similarly, other keys might be more useful if the Shifted operation of the key were implemented in a single key. For example, the cursor arrow keys are used by themselves in editing programs to position the on-screen cursor. They are also used in conjunction with the Shift key to highlight regions of text to perform subsequent editing functions (delete the highlighted region, change the case of the highlighted text, etc.). It would be advantageous if the two-handed Shift-arrow function could be performed by the cursor arrow key itself.

Because of the deficiency of the current keyboard design, there remains a need in the art for a keyboard design having a key to perform the basic key functions plus the Shifted key functions.

### SUMMARY OF THE INVENTION

The present invention provides a simple means for computer users to perform basic computer keyboard key functions and shifted key functions from the same key by providing the key with a second and mutually exclusive direction of motion, that being a rocking motion. A key press in the normal vertical motion produces the standard character or function from that key. A key press in the rocking motion activates the Shifted function of the key. So, for example, a cursor arrow key arranged to have a rocking key operation can be pressed down to move the cursor in the standard fashion, or can be rocked down to activate the Shift-arrow function, that is, moving the cursor while highlighting the region over which the cursor is moved.

Pressing a key down causes an electrical contact to be made, which is detected by the keyboard electronics. The electrical contact closes a switch on an electrical circuit path, allowing current to flow. The keyboard electronic control circuit detects this current flow and, based on the circuit paths involved, determines which key has been pressed. Pressing down a rocking key in its normal vertical direction of motion closes a switch and causes current to flow in one electrical circuit path, which is detected by the keyboard electronics and interpreted as being the basic function of the key. Rocking a key down closes a different switch and causes current to flow through a different circuit path, which is detected by the keyboard electronics and interpreted as being the Shifted function of the key.

The advantages of this arrangement are that a single key implements both the basic key function as well as the Shifted key function, and both functions can be accessed with a single hand. Although the Tab key and cursor arrow keys are discussed in particular in this document, the inventive concept may apply usefully to other keyboard keys such as the alphabetic keys.

### BRIEF DESCRIPTION OF THE DRAWINGS

The invention will be more fully understood when reference is had to the following detailed description of the preferred embodiment of the invention and the accompanying drawings, in which:

FIG. 1 is an illustration of the 83-key original IBM PC keyboard;

FIG. 2 is an illustration of the 84-key IBM PC/AT keyboard;

FIG. 3 is an illustration of the 101-key Enhanced IBM keyboard;

FIG. 4 is an illustration of the 104-key “Windows” keyboard;

FIG. 5 is an illustration of a contemporary “multimedia” keyboard;

FIG. 6 is an illustration of a keyboard electronic control circuit;

FIG. 7 is an illustration of a side view of a prior art key and associated keyboard membranes;

FIG. 8 is an illustration of a side view of the current invention and associated keyboard membranes;

FIG. 9 is an expansion of FIG. 7 additionally illustrating the keyboard top shell and the key socket;

FIG. 10 is an expansion of FIG. 8 additionally illustrating the keyboard top shell and the key socket of the current invention; and

FIG. 11 shows additional detail to the illustration of FIG. 10.

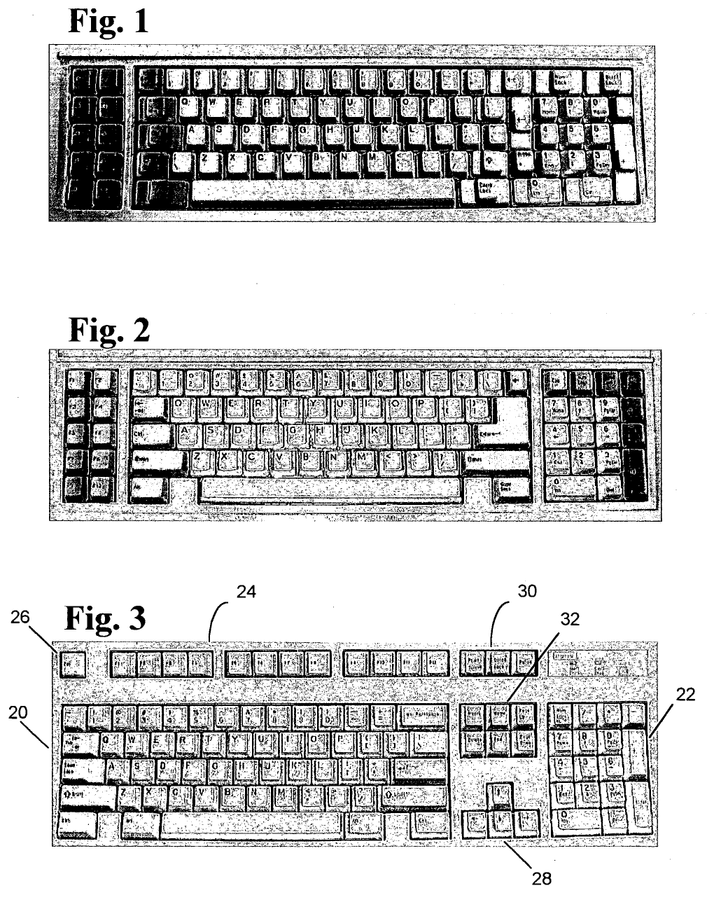

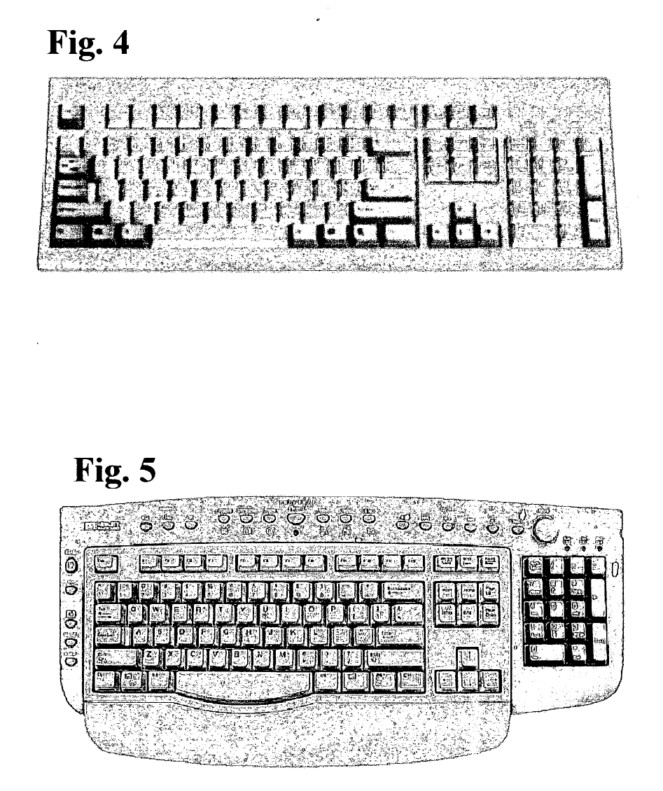

### DETAILED DESCRIPTION OF THE INVENTION

The present invention provides a simple means for computer users to perform basic computer keyboard key functions and shifted key functions from the same key by providing the key with a second and mutually exclusive direction of motion, that being a rocking motion. A key press in the normal vertical motion produces the standard character or function from that key. A key press in the rocking motion activates the Shifted function of the key. So, for example, a cursor arrow key arranged to have a rocking key operation can be pressed down to move the cursor in the standard fashion, or can be rocked down to activate the Shift-arrow function, that is, moving the cursor while highlighting the region over which the cursor is moved.

Pressing a key down causes an electrical contact to be made, which is detected by the keyboard electronics. The electrical contact closes a switch on an electrical circuit path, allowing current to flow. The keyboard electronic control circuit detects this current flow and, based on the circuit paths involved, determines which key has been pressed. Pressing down a rocking key in its normal vertical direction of motion closes a switch and causes current to flow in one electrical circuit path, which is detected by the keyboard electronics and interpreted as being the basic function of the key. Rocking a key down closes a different switch and causes current to flow through a different circuit path, which is detected by the keyboard electronics and interpreted as being the Shifted function of the key.

In contemporary keyboard designs, each key of the keyboard is wired to an electronic keyboard control circuit which detects the pressing of a key and sends a signal or message to the computer operating software identifying the key or keys that have been pressed, or a similar appropriate message. The pressing of a key closes a circuit unique to that key, allowing a current to flow through that circuit path. The electronic control detects the current flowing through the circuit path related to that key, and thus is able to determine that the key in question has been pressed.

Although there are other ways in which such a system could be implemented, in the preferred embodiment of this invention, a rocking key is associated with two uniquely identifiable circuit paths. When the electronic control circuit detects current flow in the vertical key switch circuit path it determines that the key has been pressed down in the traditional vertical motion, and sends an appropriate message or messages to the computer's operating software representing the basic function of that key. When the electronic control circuit detects current flow in the rocking circuit path for that key, it determines that the key has been rocked down, and sends an appropriate message or messages to the computer's operating software representing the shifted function of that key. Such messages might indicate separately that the Shift key has been pressed, and that another key, such as the Tab key, has been pressed.

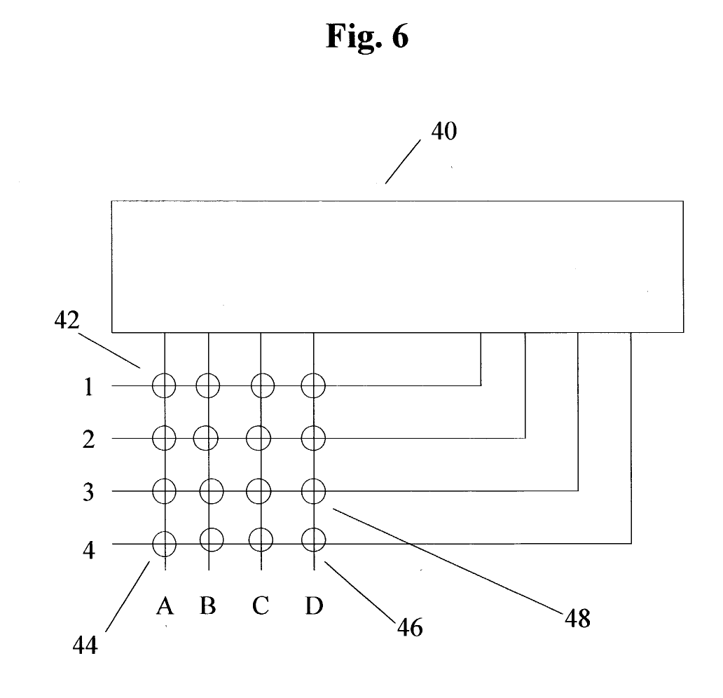

Such an arrangement is illustrated in FIG. 6, having an electronic control circuit 40 monitoring a matrix of individual circuit paths 1, 2, 3, and 4, horizontally and A, B, C, and D vertically. Circles 42 represent the switches activated by various keys on the keyboard, each switch having a unique position on the matrix. When a key is pressed it makes a connection between the pair of horizontal and vertical circuit paths associated with that key switch on the matrix. Making the connection closes the circuit, allowing an electric current to flow through the associated pair of circuit paths. For purposes of this illustration, the Shift key is associated with key switch 44, the Tab key is associated with key switch 46 in its traditional downward movement, and the Tab key in its rocking down motion is associated with key switch 48. If the Shift key switch 44 would close, the control circuit 40 would detect current flowing through circuit path A and circuit path 4 simultaneously, therefore uniquely identifying the Shift key as having been pressed. Similarly, if the Tab key were pressed straight down, key switch 46 would close and the control circuit 40 would detect current flowing through circuit path D and circuit path 4 simultaneously, therefore uniquely identifying the Tab key as having been pressed. Lastly, if the Tab key were rocked down, key switch 48 would close and the control circuit 40 would detect current flowing through circuit path D and circuit path 3 simultaneously, therefore uniquely identifying the Shifted Tab key as having been pressed. When control circuit 40 detects a key press by the above means, it sends an appropriate message or messages to the computer's operating software indicating that event. In the case of a Shifted rocking key such as the Tab key being detected, control circuit 40 sends appropriate messages to the computer's operating software indicating that the Shift key and Tab key were pressed concurrently. Thus, this invention can be implemented in the keyboard alone, without requiring any changes to the computer's operating software, keyboard driver software, or application software.

The general nature of the operation of a keyboard is as follows: messages are generated by the keyboard electronics in response to a key press, the keyboard electronics delivers the messages to the computer operating system via a keyboard driver software component, and the computer operating system delivers the messages to the software application which presents the typed characters on the computer's screen.

There are several contemporary computer hardware designs and operating systems. For example, there are currently a variety of Microsoft Windows operating systems in use, the BeOS (the Be Operating System), the Apple MacIntosh operating system, a wide variety of UNIX operating systems and derivatives including SunOS (Sun Microsystems), HPUX (Hewlett Packard), and LINUX. Each hardware and software system presents a unique method of implementing keyboard functions into the overall system by the use of keyboard driver software, system messages, etc. In addition, the keyboard functions of this invention could be implemented by hardware and operating system software not yet in existence. Therefore, the precise nature of the associated keyboard driver software and messages to be sent to the operating system or to a software application to indicate the typing of a symbol or alphabetic key or a control key such as a Shift key are beyond the scope of this patent application. It is ample to point out that the methods and means to implement such functionality are well known in the art, and individuals skilled in the art would be capable of implementing a system which could function according to this invention.

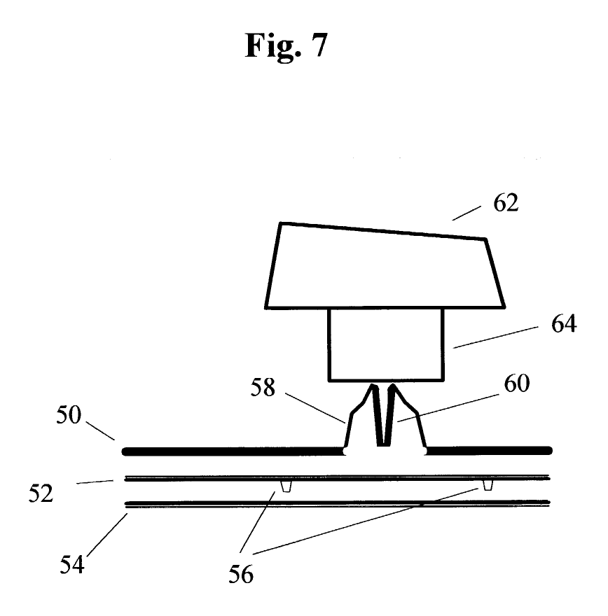

Today, the standard implementation of keyboard key switches is by three membranes, two of a plastic material and one of a rubber material sandwiched together inside the keyboard. As illustrated in FIG. 7, the rubber membrane 50 is the top layer that comes in contact with the bottom of the keyboard keys, the middle plastic layer 52 has electrically conductive traces on its bottom side, and the bottom plastic layer 54 has electrically conductive traces on its top side. The electrically conductive traces typically run in opposite directions such that the traces form an intersection under the position of each key. The electrically conductive traces are coated with an electrical insulator except at the intersection of two traces where a key is positioned, thus forming a key switch at each such juncture. Small deformations or bumps 56 formed into one or both of the plastic layers prevent the two electrically conductive surfaces at the key switch junctures from contacting each other except under the pressure of a key press. Rubber membrane 50 has nipples 58 molded into it at each key position over the intersection of the two conductive traces associated with each of those keys. The nipples 58 have a rigid central plunger 60. Keyboard key 62 has a post 64 which rests in contact with the top of nipple 58. The downward stroke of key 62 pushes nipple 58 down, compressing it. As the nipple 58 compresses, the rigid plunger 60, which does not compress, forces the plastic membranes 52 and 54 together, making electrical contact between the electrically conductive traces on their mating surfaces. A current will flow through the conductive traces (the circuit paths mentioned earlier) which will be detected by the keyboard electronic control circuit.

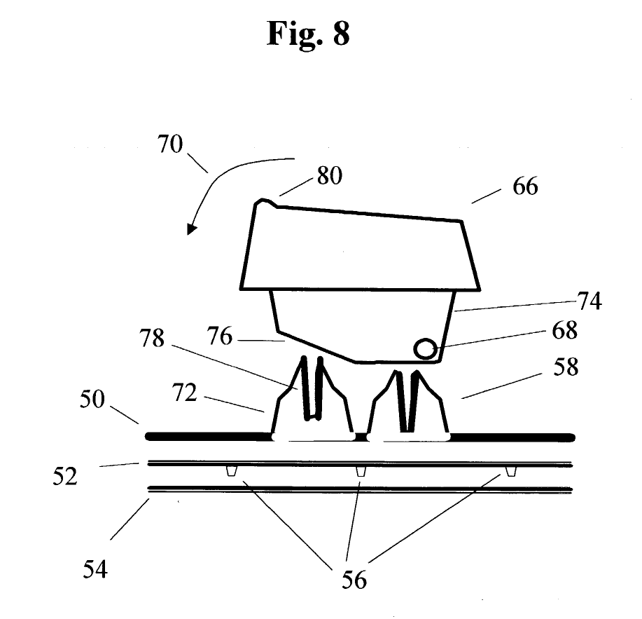

In the present invention as illustrated in FIG. 8, rocking key 66 has pivot point 68 which allows it to rotate in the direction of arrow 70. Pivot point 68 may simply be one of a pair of flanges or tabs molded opposite each other, and serving to hold the key in place in its socket (key sockets, not shown, are molded into the top shell of the keyboard). The nipple 58 which provides contact switch closure for the traditional downward keystroke is supplemented with another nipple 72 which has below it the intersection of two additional conductive traces. Nipple 72 provides contact closure for the rocking keystroke. Nipple 72 is taller than nipple 58 to contact the bottom of rocking key 66, while having a shorter plunger 78 than plunger 60. This arrangement prevents the contacts under nipple 72 from making closure when the key 66 is pressed straight down. Nipples 58 and 72 are isolated from influencing each other by strategically placed deformations 56. Key post 74 is tapered inward from the key top toward pivot point 68 to allow rotational motion without binding against the inside of the key socket. Key post 74 has an angled portion 76 oriented to contact nipple 72, with the angle arranged to provide the maximum downward movement of the surface that contacts nipple 72. The top of key 66 has a raised portion 80 suggestive of the direction to push the key to activate the rocking function. The top of key 66 may also bear a distinctive marking suggestive of this function.

Pressing rocking key 66 straight down operates in the same fashion and causes the same response as just described for FIG. 7. However, rocking the key 66 about pivot point 68 in the direction of arrow 70 causes nipple 72 to force the plastic membranes 52 and 54 together at the juncture of nipple 72, making electrical contact between the electrically conductive traces on their mating surfaces which will be detected by the keyboard electronic control circuit. By identifying the particular conductive traces carrying this current flow, the electronic control circuit will identify the switch closure as being associated with the Shifted function of the key that has been pressed.

The rotational and downward movements of the rocking key 66, and their associated key switch contact closures, are mutually exclusive. When rocking key 66 is pressed straight down, plunger 78 of nipple 72 does not compress membranes 52 and 54 together, and thus does not make an inappropriate key switch contact closure. Similarly, when rocking key 66 is rocked down, since it pivots about point 68, nipple 58 and plunger 60 are not pressed downward and do not compress membranes 52 and 54 together, thus also not making an inappropriate key switch contact closure.

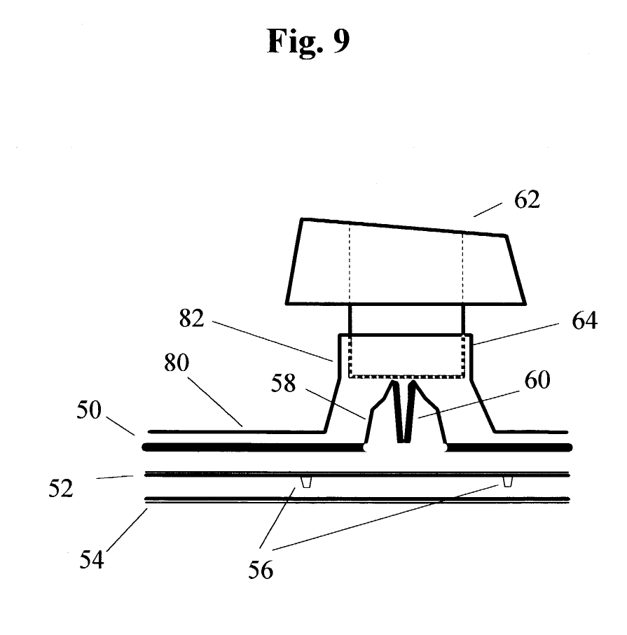

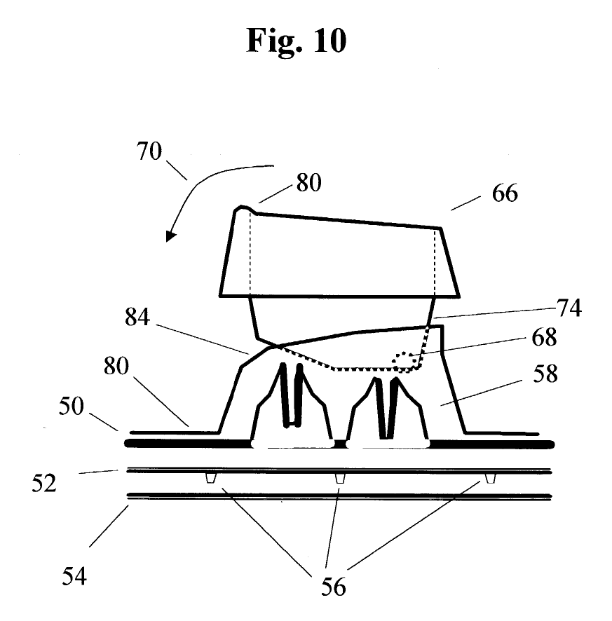

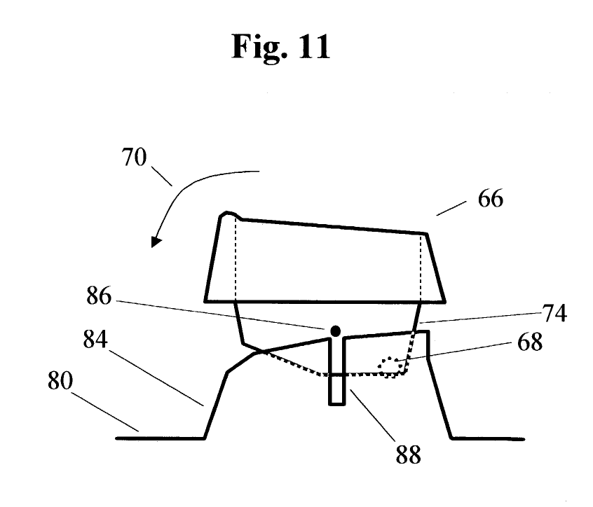

FIG. 9 presents the same illustration as FIG. 7 with the addition of the plastic shell 80 that forms the top of the keyboard, and the key sockets 82 which are molded in. Key sockets 82 are square, hollow projections the size of sugar cubes which position the key posts 64 at the proper locations. FIG. 10 shows plastic shell 80 for the rocking key, having key sockets 84. Whereas the key sockets 82 are basically square, the key sockets 84 have an angled top to accommodate the rotational motion of the key. FIG. 11 repeats parts of FIG. 10 to show the additional details of pin 86 extruding from the side of key post 74, and slot 88 formed as part of key socket 84. In the rest state of key 66, pin 86 sits above slot 88. When key 66 is moved downward an arbitrary but small amount, perhaps less than 1/64th of an inch (0.0156), pin 86 becomes engaged in slot 88 and prevents rotational movement of the key while allowing unrestricted upward and downward movement of the key. Conversely, when key 66 is rotated forward a similarly arbitrary but small amount from its rest position, projecting pin 86 encounters the top of the key socket 84, preventing the key 66 from moving downward. Thus, the combination of pin 86 and slot 88 provides for mutually exclusive motions of key 66; that is to say, if the key is being rocked forward, it cannot simultaneously be pressed downward, and if the key is being pressed downward, it cannot simultaneously be rocked forward.

Having thus described the invention in rather full detail, it will be understood that such detail need not be strictly adhered to, but that further changes and modifications may suggest themselves to one skilled in the art falling within the scope of the present invention as defined by the subjoined claims.

What is claimed is:

1. A computer keyboard having keys for generating characters, comprising:
a. electronic control circuitry having an association of said keys with the meanings for said keys, said electronic control circuitry detecting the activation of said keys and sending appropriate messages to an associated computer system identifying such activation events;
b. keys for generating alphabetic characters, white space characters, and for performing control functions such as cursor movement and navigation, and editing, said characters and functions being the meanings of said keys;
c. a dual movement key having two directions of motion, one of said directions of motion being approximately vertical and the other being rotationally upward and downward about an axis point near the bottom of said key; and
d. said dual movement key being associated with two key meanings, a vertical key meaning associated with said vertical direction of motion, and a rotational key meaning associated with said rotational direction of motion.

2. A computer keyboard having keys for generating characters as recited in claim 1, further comprising:
a. a Shift key, said messages of said key activation events associated with said Shift key causing said associated computer system to modify the meaning of typed alphabetic character keys to be that of capital letters when said Shift key is concurrently activated with said typed alphabetic character keys, and to modify the meaning of other keys such as by causing the Tab to move in the right-to-left direction rather than in the left-to-right direction; and
b. said rotational movement of said dual movement key being concurrently associated with said vertical key meaning and said shift key activation, as if said vertical key activation and Shift key activation occurred concurrently.

3. A computer keyboard having keys for generating characters as recited in claim 2 wherein said vertical key meaning is that of the Tab key.

4. A computer keyboard having keys for generating characters as recited in claim 2 wherein said vertical key meaning is that of a cursor arrow navigation key.

5. A computer keyboard having keys for generating characters as recited in claim 2 wherein said vertical key meaning is that of an alphabetic key.

6. A computer keyboard having keys for generating characters as recited in claim 1 wherein said vertical movement and rotational movement are mutually exclusive at any given moment.
